(19) United States
(12) Patent Application Publication
(10) Pub. No.: US 2004/0203828 A1
(43) Pub. Date: Oct. 14, 2004

(54) Selective channel assignment in a wireless data communications network

(76) Inventors: Vinod Mirchandani, Sydney (AU); Eryk Dutkiewicz, Figtree (AT)

Correspondence Address: MOTOROLA, INC., 1303 EAST ALGONQUIN ROAD, IL01/3RD, SCHAUMBURG, IL, 60196

(21) Appl. No.: 10/313,366

(22) Filed: Dec. 6, 2002

(51) Int. Cl. H04Q 7/20; H04M 1/00

(52) U.S. Cl. 455/452.1; 455/561; 370/329; 370/431

(57) ABSTRACT

The invention provides for dynamic channel/capacity assignment within an 802.11 wireless data communications network (10) consisting of several access points (20). The access points are linked to each by inter access point channels 11. Each access point 20 has an associated local coverage area 13 which services roaming terminal devices 14 or local 802.11 stations. The invention allows for increased throughput between the access points or between an access point and local stations within the local coverage area of the access point (20) by allowing additional channel capacity to be dynamically re-assigned. The invention provides a degree of quality of service for multimedia traffic transfer in wireless networks such as the 802.11 based extended service set.

### FIELD OF THE INVENTION

This invention relates to selective channel assignment in a wireless data communications network. The invention is particularly useful for, but not necessarily limited to, selective channel assignment in a network system organised and operating according to the IEEE 802.11 standard.

### BACKGROUND OF THE INVENTION

Current wireless network systems, such as systems using the 802.11 standard, have been focused more upon local area coverage rather than coverage of large metropolitan areas. Emerging Wireless Local Area Network (WLAN) technologies based on the 802.11 standard are poised for use in large metropolitan areas by utilising wireless connections between access points.

Capacity requirements for seamless 802.11 standard communications varies based upon numerous factors such as time of day, seasonal demand and local emergencies, to name just a few. Currently capacity and connection assignment is based on traditional fixed WLAN channel assignment schemes within a local coverage area. Furthermore, most schemes do not readily address the need for providing extra capacity to access points within the metropolitan area that have demands for additional capacity to accommodate additional traffic.

Channel assignment methods have been proposed for use with cellular communications systems. One such example is U.S. Pat. No. 5,956,643 entitled Apparatus and Method for Adaptive Dynamic Channel Assignment in Wireless Communications Networks. This patent discloses a channel assignment system that assigns channels to various cells by the optimal partitioning of the available radio frequencies into non-overlapping sets. The optimal grouping of co-user cells, and the best assignment of the former to the latter. The objective in this case is maximization of traffic handling capacity which, given the multitude of cells, is expressed as the maximization of a bottleneck capacity ratio.

U.S. Pat. No 5,309,503 entitled Dynamic channel assignment in a communications system describes a method of dynamic channel assignment in a communications system based on signal quality value reported by the receiving base station to a system controller. The system controller determines the best signal quality value reported and assigns the channel to the base station that reported the best signal quality.

In U.S. Pat. No 6,052,596 entitled System and method for dynamic channel assignment there is disclosed a method where channel assignment is conducted by measuring the RF characteristics and then computing the signal to impairment ratio.

U.S. Pat. No 5,790,551 entitled Packet data transmission using dynamic channel assignment describes a method for dynamic channel assignment in a cellular system by a mobile end system sending a request for assignment of channel for transmission of data. The network responds with the identification of a particular channel that may be used for a particular time period to transmit data. In this case the network decides the channel that will be free for the specified time period and assigns it for data transmission.

In Sanket Nesargi and Ravi Prakash, Distributed Wireless Channel allocation in Networks with Mobile Base Stations, Proceeding of Infocom 1999, Vol 2 pages 592-600, there is described a signalling mechanism for channel allocation in a cellular system. The channel allocation mechanism in this paper is described for use in a cellular mobile telephone system. The method described allocates channels from the base stations only if they are not being used.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed. Throughout the specification the terms dynamic capacity assignment and dynamic channel assignment are used interchangeably.

### SUMMARY OF THE INVENTION

According to one aspect of the invention there is provided a method for selective channel assignment in a wireless data communications network, the network having a plurality of access points, each of the access points having a limited number of channels for either selective intra access point communication with remote communications units in a local coverage area of the access point or inter access point communication with other access points in the network, the method comprising:

determining a need of a requesting access point to re-assign a channel;

sending a channel request, from the requesting access point to at least part of the network;

receiving offers for potentially available channels from the network, the potentially available channels being channels that are currently providing either intra access point communication or inter access point communication;

selecting one of said potentially available channels to thereby identify a selected channel;

transmitting an acceptance message to at least part of the network indicating the identity of said selected channel; and

re-assigning said selected channel by said requesting access point.

Preferably, the re-assigning may be characterized by the selected channel being made available by at least one of said remote communications units.

Suitably, the selecting is based upon quality of service criteria.

Preferably, the determining is based upon quality of service criteria.

The re-assigning may be for a desired communication with another access point.

Preferably, the re-assigning may be for a desired communication with a remote communications unit.

Suitably, sending a channel request may be conducted by concurrently broadcasting said channel request to all communications units.

Preferably, the sending a channel request may be conducted by sending said channel request hop by hop between said access points.

Preferably, the wireless data communications network may employ an IEEE 802.11 architecture.

Suitably, the communications units may be portable radio transceivers.

According to another aspect of the invention there is provided an access point for a wireless data communications network, the access point having a controller and transceiver coupled to the controller, the transceiver having a having a limited number of channels for either selective intra access point communication with remote communications units in a local coverage area of the access point or inter access point communication with other access points in the network, wherein in use, when the access point determines a need to re-assign a channel the access point provides for:

sending a channel request, from the requesting access point to at least part of the network;

receiving offers for potentially available channels from the network, the potentially available channels being channels that are currently providing either intra access point communication or inter access point communication;

selecting one of said potentially available channels to thereby identify a selected channel;

transmitting an acceptance message to at least part of the network indicating the identity of said selected channel; and

re-assigning said selected channel by said requesting access point.

Suitably, the access point determines a need to re-assign a channel that me be based upon quality of service criteria.

Preferably, the re-assigning may be for a desired communication with another access point.

Suitably, the re-assigning may be for a desired communication with a remote communications unit.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a schematic block diagram of a wireless data communications network according to the present invention;

FIG. 2 is a schematic block diagram of an access point of FIG. 1, the access point having channels initially allocated to communicate with at least one other access point and remote communications units;

FIG. 3 is a schematic block diagram of the access point of FIG. 2, when one of the channels is re-allocated by intra access point channel assignment;

FIG. 4 is a schematic block diagram of the access point of FIG. 2, when one of the channels is re-allocated by inter access point channel assignment; and

FIGS. 5a and 5b are flow charts illustrating a method for selective channel assignment in the wireless data communications network of FIG. 1 in accordance with the present invention.

### DETAILED DESCRIPTION OF A PREFERRED EMBODIMENT OF THE INVENTION

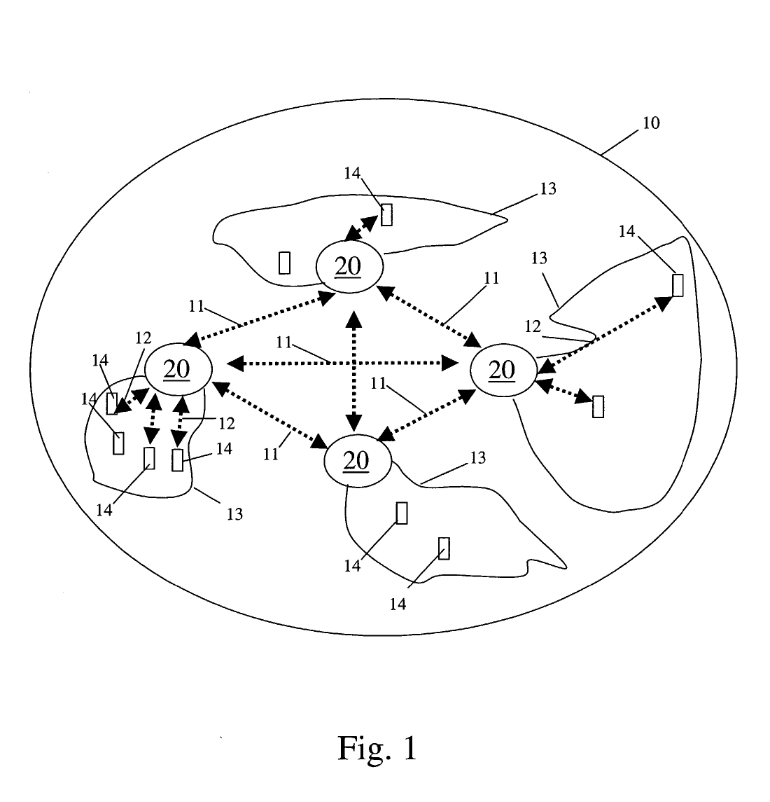

In the drawings, like numerals on different Figs are used to indicate like elements throughout. Referring to FIG. 1 there is illustrated a wireless data communications network 10 in the form of an 802.11 extended service set consisting of several access points 20. The access points 20 are linked to each other via a wireless distribution system in the form of channels 11 (for inter access point communication).

Each access point 20 has an associated local coverage area 13 which services remote communications units 14 (local 802.11 stations). Each access point is in communication with one or more remote communications units 14 in its associated coverage area 13 by wireless channels 12 (for intra access point communication). These remote communications units 14 may be stationary or mobile such as roaming portable radio transceivers.

The access points 20 enable the communications units 14 to communicate with other communications units 14 in the same local coverage area 13 (for intra access point communication). The access points 20 also enable the communications units 14 to communicate with other communications units 14 associated with other access points 20 in another local coverage area 13 (for inter access point communication).

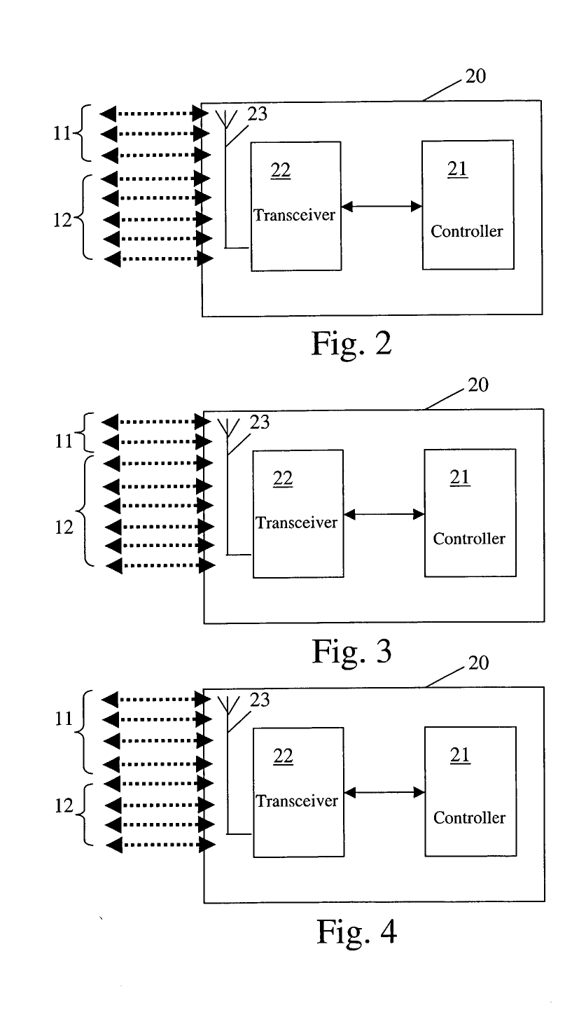

Referring to FIG. 2 there is illustrated a schematic block diagram of an access point 20. The access point comprises a Medium Access Controller 21 coupled to control an 802.11 radio transceiver 22 having an antenna 23. The radio transceiver 22 is configured to communicate over a pre-defined number of channels 11,12. Typically there are 8 such channels 11,12 for the 802.11a WLAN. As shown, there are three channels 11 initially allocated to communicate with three other access points (inter access point communication) and five channels 12 allocated to communicate with remote communications units 14 (intra access point communication).

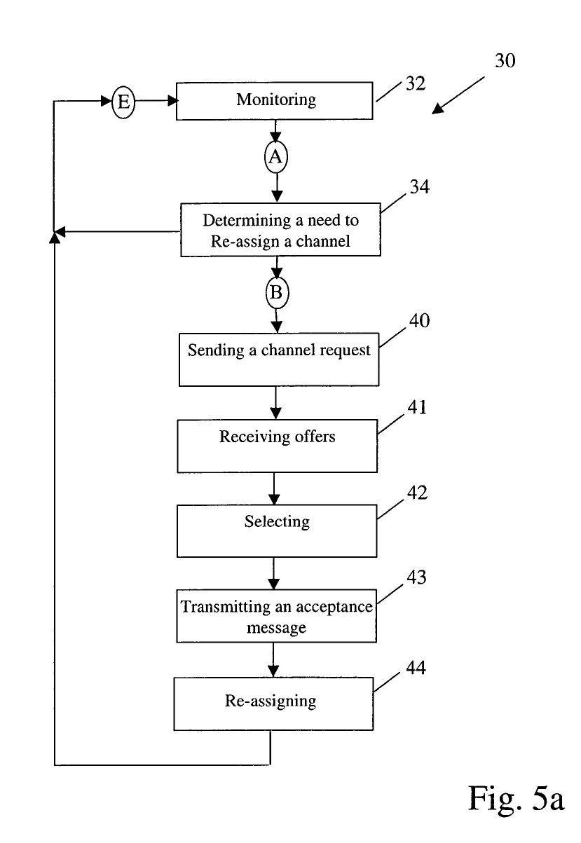

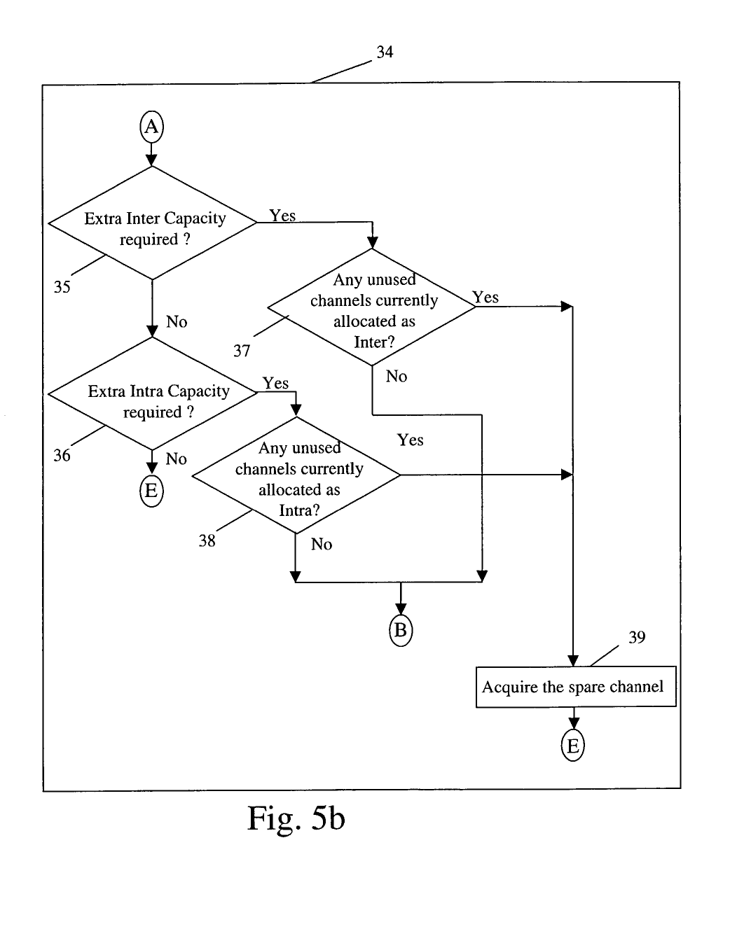

Referring to FIGS. 5a and 5b there is illustrated a method 30 for selective channel assignment in the wireless data communications network 10. As will be apparent from the above, the network 10 has a limited number of channels. These channels are for either: (a) selective intra access point communication designated as the channels 12, with remote communications units 14 in the local coverage area 13 of the access point 20; or (b) inter access point communication designated as the channels 11 with other access points 20 in the network 10.

Upon establishment of the wireless data communications network 10 each access point 20 forms channels 12 with the remote communications units 14 in its local coverage area 13 to form intra access point communication. Also each access point 20 forms channels 11 with the other access points 20 to provide inter access point communication. Hence, by way of example as shown in FIG. 2, all access points 20 of the network 10 initially have three channels 11 for inter access point communication and five channels 12 for intra access point communication.

The method 30 performs a monitoring step 32 where there is effected monitoring of communications traffic by each of the access point's allocated channels 12 (for intra access point communication) and channels 11 (for inter access point communication).

Each access point 20 has a radio resource management table. The table stores peak traffic values permitted by the network provider for each service type per channel 11, 12 both locally and between neighbouring access points 20 allowing a degree of quality of service to be achieved. The radio resource management table could also store other threshold traffic values instead of the peak traffic values for each service type. This can be based on the WLAN service provider policy as is well known in the art.

After monitoring 32, each access point 20 may determine, at a determining step 34, if extra channel capacity (for intra or inter access point communication) is required to effect a desired communication with a communications unit 14 or another access point. The determining step is based on quality of service criterion and uses the radio resource management table. Accordingly, an access point 20 requiring extra channel capacity is referred to as a requesting access point 20. Thus the determining step 34 provides for determining a need of a requesting access point 20 to re-assign a channel.

The determining step 34 is described in detail in FIG. 5b where at test step 35 it is determined if extra inter capacity is required (for inter access point communication) by a requesting access point 20. If the test step 35 determines extra inter capacity is not required a test step 36 is effected, otherwise a test step 37 is effected. The test step 37 determines if there are any unused channels 11 currently allocated as inter (allocated for inter access point communication). If the test step 37 determines that there are no unused channels 11 then the determining step 34 is completed, otherwise a step 39 is conducted to use the spare channel 11 by the requesting access point 20. Step 34 is then completed and the method returns to the monitoring step 32.

Returning to test step 36 where there is conducted a test to determine if extra intra capacity is required (for intra access point communication) by a requesting access point 20. If test step 36 determines extra intra capacity is not required then step 34 is completed, and the method returns to the monitoring step 32, otherwise a test step 38 is conducted. The test step 38 determines if there are any unused channels 12 currently allocated as intra (allocated for intra access point communication). If the test step 38 determines that there are no unused channels 12 then the determining step 34 is completed, otherwise a step 39 is conducted to use the spare channel 12 by the requesting access point 20. Step 34 is then completed and the method returns to the monitoring step 32.

Returning to FIG. 5a, if the determining step 34 determines a need for the requesting access point 20 to re-assign a channel and no channels 11,12 are designated for the desired form of communication (intra or inter), then a sending a channel request step 40 is effected from the requesting access point 20 to at least part of the network 10. This is typically achieved by: (a) concurrently broadcasting the channel request to all access points 20; or (b) sending the channel request hop by hop between the access points 20.

The requesting access point 20 then receives offers of potentially available channels from the prospective donor access points 20 at a receiving offers step 41. Thus, step 41 provides for receiving offers for potentially available channels from the network 10, the potentially available channels being channels that are currently providing either intra access point communication by channels 12 or inter access point communication by channels 11.

Once the offers have been received, the requesting access point 20 then screens the potentially available channels and selects the appropriate channel based on predetermined quality of service selection criteria and makes use of the radio resource management table. This is performed at a selecting step 42 for selecting one of potentially available channels to thereby identify a selected channel.

After the selecting step 42, the requesting access point 20 performs a step of transmitting an acceptance message 43 to at least part of the network 10 indicating the identity of said selected channel. Typically, the transmitting would usually be in the form of a broadcast to at least part of the network 10. A re-assigning step 44 is then effected whereby a donor access point(s) 20 then closes the selected channel, that was being used by the donor access point(s) 20, and informs the requesting access point 20 with a closure message. The requesting access point 20 then acknowledges the closure message from the donor access point(s) 20. The re-assigning step 44 thereby performs re-assigning the selected channel by the requesting access point 20.

The requesting access point 20 then establishes communication (the desired communication), using the selected channel, with either: (a) another access point 20; or (b) with one of the remote communications units 14 within the local coverage area 13 of the requesting access point 20.

If the selected channel is desired for communication with one of the remote communications units 14, within the local coverage area 13, the channels dynamically allocated by the requesting access point 20 are allocated as shown in FIG. 3. As shown in FIG. 3, there are now two channels 11 allocated to communicate with two other access points (inter access point communication) and six channels 12 allocated to communicate with remote communications units 14 (intra access point communication) . Accordingly, the selected channel has been made available by another access point 20 that was using the selected channel (in this case one of the channels 11) for inter access point communication.

If the selected channel is desired for communication with one of the access points 20, the channels dynamically allocated by the requesting access point 20 are allocated as shown in FIG. 4. As shown in FIG. 4, there are now four channels 11 allocated to communicate with four other access points (inter access point communication) and four channels 12 allocated to communicate with remote communications units 14 (intra access point communication). Accordingly, the selected channel has been made available by a communications unit 14 that was using the selected channel (in this case one of the channels 12) for intra access point communication.

Advantageously, the present invention can in use enable a requesting access point 20 to send a channel request (for instance using hop by hop signalling) to all the other access points 20 within the wireless data communications network 10 requesting they shut down a channel 11,12 for donation. The access points 20 in the wireless data communications network 10 then determine by comparing their inter access point 20 traffic load and the quality of service information in the local radio resource management table if it is possible to shut down a channel for donation. The access points 20 in the wireless data communications network 10 then send a report message for this request to the requesting access point.

After receiving responses to the request messages from several access points 20 in the wireless data communications network 10 the requesting access point 20 will then determine the access point(s) 20 that will be least affected by the closure of a channel 11, 12. The term least affected here means the neighbouring access points 20 that could compromise on traffic transfer. For example, a suitable criterion that may be used could be the cost to usage ratio or quality of service criteria.

The requesting access point 20 will then typically send a broadcast message hop-by-hop to the access points 20 in the wireless data communications network 10 notifying them of the selection of an access point(s) 20 whose channel has been selected for closure.

The donor access point(s) 20 whose channel has been selected for closure will then close the channel 11, 12 and inform the requesting access point 20. This requesting access point 20 will then send back an acknowledge message to the donor access point(s) 20. The purpose of the acknowledge message is to confirm acceptance of the borrowed channel.

For inter access point communication, the requesting access point 20 will notify the neighbouring access point(s) 20 about the pending formation of a second link with it on the borrowed channel. The neighbouring access points 20 can, if required by the protocol, then confirm its readiness to form the new channel 11 by sending an acknowledge message to the requesting access point 20. The requesting access point may then test the channel 11 for interference before sending data on the borrowed channel.

Once the channel 11, 12 is borrowed by the requesting access point 20 it is free to form the link with the requesting local stations 14 by using the process outlined in the proposed 802.11 standard, which includes dynamic frequency selection and transmit power control options for the access points.

Further to the above, the present invention enables provision of quality of service classes across access points 20 as well as within the local coverage area 13 of an access point 20.

The detailed description provides preferred exemplary embodiments only, and is not intended to limit the scope, applicability, or configuration of the invention. Rather, the detailed description of the preferred exemplary embodiments provides those skilled in the art with an enabling description for implementing a preferred exemplary embodiment of the invention. It should be understood that various changes may be made in the function and arrangement of elements without departing from the spirit and scope of the invention as set forth in the appended claims.

We claim:

1. A method for selective channel assignment in a wireless data communications network, the network having a plurality of access points, each of the access points having a limited number of channels for either selective intra access point communication with remote communications units in a local coverage area of the access point or inter access point communication with other access points in the network, the method comprising:
determining a need of a requesting access point to re-assign a channel;
sending a channel request, from the requesting access point to at least part of the network;
receiving offers for potentially available channels from the network, the potentially available channels being channels that are currently providing either intra access point communication or inter access point communication;
selecting one of said potentially available channels to thereby identify a selected channel;
transmitting an acceptance message to at least part of the network indicating the identity of said selected channel; and
re-assigning said selected channel by said requesting access point.

2. The method of claim 1, wherein the re-assigning is characterized by the selected channel being made available by at least one of said remote communications units.

3. The method of claim 1, wherein the selecting is based upon quality of service criteria.

4. The method of claim 1, wherein the determining is based upon quality of service criteria.

5. The method of claim 1, wherein the re-assigning is for a desired communication with another access point.

6. The method of claim 1, wherein the re-assigning is for a desired communication with a remote communications unit.

7. The method of claim 1, wherein the sending a channel request is conducted by concurrently broadcasting said channel request to all communications units.

8. The method of claim 1, wherein the sending a channel request is conducted by sending said channel request hop by hop between said access points.

9. The method of claim 1 wherein the wireless data communications network employs an IEEE 802.11 architecture.

10. The method of claim 1 wherein the communications units are portable radio transceivers.

11. An access point for a wireless data communications network, the access point having a controller and transceiver coupled to the controller, the transceiver having a having a limited number of channels for either selective intra access point communication with remote communications units in a local coverage area of the access point or inter access point communication with other access points in the network, wherein in use, when the access point determines a need to re-assign a channel the access point provides for:
sending a channel request, from the requesting access point to at least part of the network;
receiving offers for potentially available channels from the network, the potentially available channels being channels that are currently providing either intra access point communication or inter access point communication;
selecting one of said potentially available channels to thereby identify a selected channel;
transmitting an acceptance message to at least part of the network indicating the identity of said selected channel; and
re-assigning said selected channel by said requesting access point.

12. The access point of claim 11, wherein the access point determines a need to re-assign a channel based upon quality of service criteria.

13. The access point of claim 11, wherein the re-assigning is for a desired communication with another access points.

14. The access point of claim 11, wherein the re-assigning is for a desired communication with a remote communications unit.
